(19) United States
(12) Patent Application Publication
(10) Pub. No.: US 2024/0424963 A1
(43) Pub. Date: Dec. 26, 2024

(54) VENTILATED VEHICLE SEAT WITH AIR DELIVERED IN A PARALLEL DIRECTION TO THE PASSENGER

(71) Applicant: FRIA GROUP LLC, Dover, DE (US)

(72) Inventor: Eric Jun-Ho Song, Monterey Park, CA (US)

(21) Appl. No.: 18/362,683

(22) Filed: Jul. 31, 2023

Related U.S. Application Data
(60) Provisional application No. 63/522,810, filed on Jun. 23, 2023.
(60) Provisional application No. 63/522,363, filed on Jun. 21, 2023.

(51) Int. Cl. B60N 2/56

(52) U.S. Cl. CPC B60N 2/5657; B60N 2/5635; B60N 2/5628

(57) ABSTRACT

A car seat cushion can decrease passenger discomfort by allowing hot and cold conditioned air to be directed from an automobile, such as from the automobile vent, directly onto the backside of the passenger. The car seat cushion can include a breathable covering with an internal air passageway system. The internal air passageway system permits air to flow along the breathable covering, in a direction generally parallel to the user seated in the car seat. The internal air passageway system can permit the air to exit at a distal end of the car seat cushion, thus ensuring continual flow of the conditioned air through the car seat cushion. The cushion can be connected to the automobile vent via a hose system with a fan to help provide adequate air flow.

### CROSS-REFERENCE TO RELATED APPLICATIONS

This application claims the benefit of priority of U.S. provisional patent application No. 63/522,810, filed Jun. 23, 2023 and U.S. provisional patent application No. 62/522,363, filed Jun. 21, 2023, the contents of both of which are herein incorporated by reference.

### BACKGROUND OF THE INVENTION

### 1. Field of the Invention

Embodiments of the invention relate generally to the field of heating, ventilation, and air conditioning in automobiles, and, more particularly, to a car seat cushion that provides further comfort by directing the heating, ventilation, and air conditioning.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Often times, the outside weather can reach extreme hot or cold temperatures where the automobile ventilation system is not enough to cool or warm its passengers. Passengers will perspire on the backside of their bodies during extreme hot temperatures, and passengers will feel chilly during extreme cold temperatures. Few luxury automobiles have a fan cooled seat or heated seat to counteract this, but most automobiles do not have this luxury. Furthermore, rear passengers and children sitting in a separate car seat for safety do not have this luxury as well.

There are a few designs of car seat cushions on the market that use the conventional idea of pushing air with a fan.

FIG. 1 illustrates one conventional style of a car seat cushion 100. In this style, a fan 102 (or sets of fans) pushes air through a cushion made of a breathable mesh 104 on the outside (facing the body), a plastic piece with ridges, and an unbreathable fabric facing the seat. In this way, the plastic piece with ridges would create openings for the pushed air to pass through and reach the breathable mesh. The forced air would then exit the breathable mesh and push against the body in a perpendicular direction, as illustrated by arrows 106, and leave in various areas around the body. This is very inefficient due to conditioned air not being able to flow or to only flow out of the breathable mesh 104 that is not covered by part of the user's body. Air velocity thus reaches zero at the point of contact with the passenger and, therefore, minimal heat transfer occurs.

In view of the foregoing, there is a need for an improved car seat heating or cooling pad.

### SUMMARY OF THE INVENTION

Aspects of the present invention provide a car seat cushion that has several improved aspects. In some embodiments, the car seat cushion can connect to the automobile air vent and can utilize the conditioned cold or hot air. A vent adapter can connect to the car air vent to provide the initial connection to conditioned air. The conditioned air then travels through a hose, such as a vacuum hose, and reaches a fan. The fan can then push the conditioned air into the car seat cushion.

The car seat cushion can maintain the air passageway despite the weight of the passenger. In conventional car seat cushions, the weight of the body often closes fully or partially the air passageways that reach the body of the passenger.

The car seat cushion can include a breathable mesh footprint combined with an end opening on the far end of the cushion. Conventional car seat cushions have a breathable mesh so that forced air can push in a perpendicular direction against the body. To the contrary, aspects of the present invention can push air not against the body, but out to the end opening on the far end of the cushion in a parallel direction, against the body. This advantageously cools or warms the body by passing the conditioned air next to the body and then out and away from the body.

Embodiments of the present invention provide a seat cushion for supporting a passenger comprising an air inlet located at a first end of the seat cushion; an air exit located at a second end of the seat cushion, the second end being opposite the first end; and an air flow path operable to permit air flow from the air inlet to the air exit, the air flow path being located along at least one of a seat back portion and a seat portion of the seat cushion, the air flow path providing an air flow in a direction generally parallel to a plane defined by an outer surface of the seat cushion.

Embodiments of the present invention provide a seat cushion for supporting a passenger comprising an air inlet located at a first end of the seat cushion; a fan for delivering fan pushed air into the air inlet; an air exit located at a second end of the seat cushion, the second end being opposite the first end; an air flow path operable to permit air flow from the fan to the air exit, the air flow path being located along at least one of a seat back portion and a seat portion of the seat cushion, the air flow path providing an air flow in a direction generally parallel to a plane defined by an outer surface of the seat cushion; and a two-piece perforated member defining the air flow path between the two pieces.

Embodiments of the present invention provide a seat cushion for supporting a passenger comprising an air inlet located at a first end of the seat cushion; a hose fluidly connecting the air inlet with an air vent of a vehicle; an air exit located at a second end of the seat cushion, the second end being opposite the first end; an air flow path operable to permit air flow from the fan to the air exit, the air flow path being located along at least one of a seat back portion and a seat portion of the seat cushion, the air flow path providing an air flow in a direction generally parallel to a plane defined by an outer surface of the seat cushion; and a two-piece perforated member defining the air flow path between the two pieces.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a perspective view of a conventional seat cushion;

FIG. 2A illustrates a car seat having the car seat cushion according to an exemplary embodiment of the present invention;

FIG. 2B illustrates a child car seat or booster seat having the car seat cushion according to an exemplary embodiment of the present invention;

FIG. 2C illustrates a detailed view taken along box C of FIG. 2B of the construction of the car seat cushion of FIGS. 2A and 2B;

FIG. 2D illustrates a connection between a fan connector and a hose on the car seat cushion shown as a detail of box D of FIGS. 2A and 2B;

FIG. 3 illustrates a side view of a rear seat showing the connection between the car seat cushion and a conditioned air vent of a vehicle;

FIG. 4 illustrates a back view of a front seat showing the connection between the car seat cushion and a passenger-side conditioned air vent of a vehicle;

FIG. 5 illustrates a back view of a front seat showing the connection between the car seat cushion and a driver-side conditioned air vent of a vehicle;

FIG. 6 illustrates a detailed front view of a connection between the hose and the air port of the vehicle; and

FIG. 7 illustrates a detailed view of a hose adaptor attached to an air vent of the vehicle.

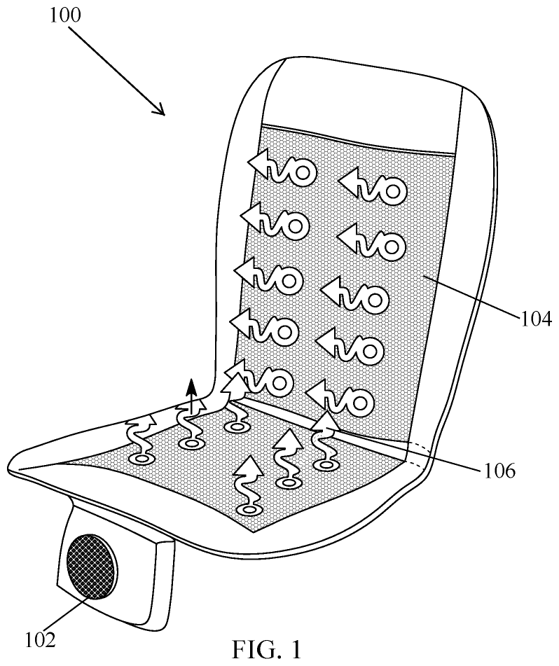

The illustrations in the figures may not necessarily be drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a car seat cushion that decreases passenger discomfort by allowing hot and cold conditioned air to be directed from an automobile, such as from the automobile vent, directly onto the backside of the passenger. The car seat cushion can include a breathable covering with an internal air passageway system. The internal air passageway system permits air to flow along the breathable covering, in a direction generally parallel to the user seated in the car seat. While some of the air flow may be directed outward toward the breathable material of the seat cushion, the majority of the air flow is in a direction parallel to a plane defined by the outer surface of the seat cushion. The internal air passageway system can permit the air to exit at a distal end of the car seat cushion, thus ensuring continual flow of the conditioned air through the car seat cushion. Thus, the air flow can be continuous and the velocity may not be reduced during use of the seat cushion. The cushion can be connected to the automobile vent via a hose system with a fan to help provide adequate air flow.

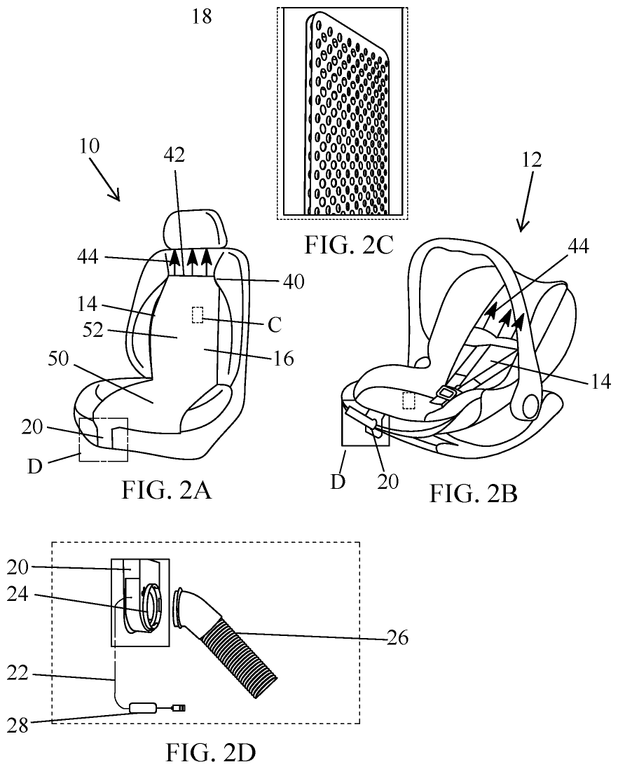

Referring to FIGS. 2A through 2D, a car seat 10 or a child seat 12 can include a seat cushion 14 that can provide conditioned air to a user sitting therein. The seat cushion 14 can include a breathable fabric 16 with a perforated plastic 18. The perforated plastic 18 can be made with two plastic pieces that can maintain the air passageway therebetween while supporting the weight of the passenger.

A fan 20 can be disposed at the bottom of the car seat cushion 14. For example, as shown in FIGS. 3A and 3B, the fan 20 may be located at a front portion of the seat 10 of the front portion of the child seat 12. The fan 20 can include a power cord 22 that may connect to power via various techniques, such as plugging into a 12V DC outlet, hard wiring, or the like. The fan 22 may be powered by a fan controller 28, which may be used to turn the fan 22 on and off and may also offer the ability to adjust the speed of the fan 22, for example. The fan 22 can include a connector 24 for removably attaching a hose 26. The hose 26 can attach to a conditioned air vent, as described below. The connector 24 may be formed in various manners, provided that the connector 24 provides a removable connection between the fan 22 and the hose 26. Such a connection can include a twist-lock connector, a friction fit connector, a resilient pin lock connector, or the like.

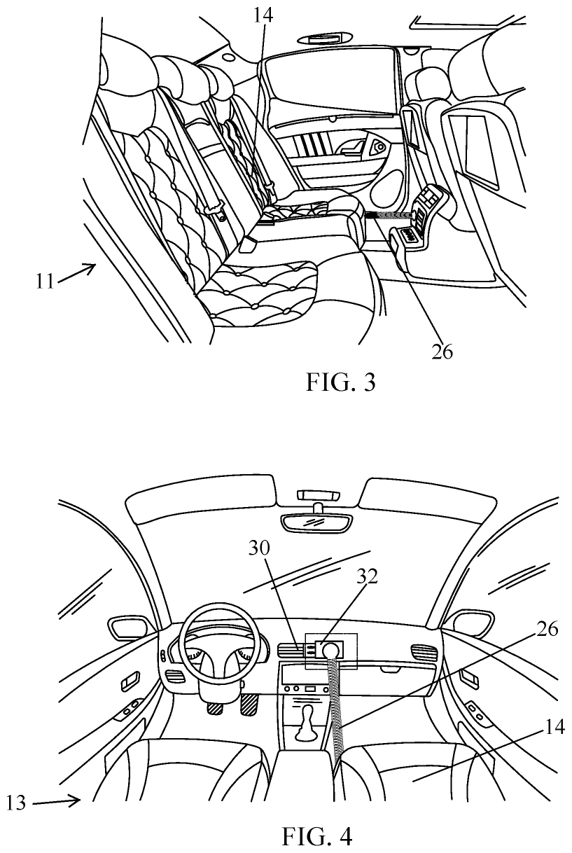

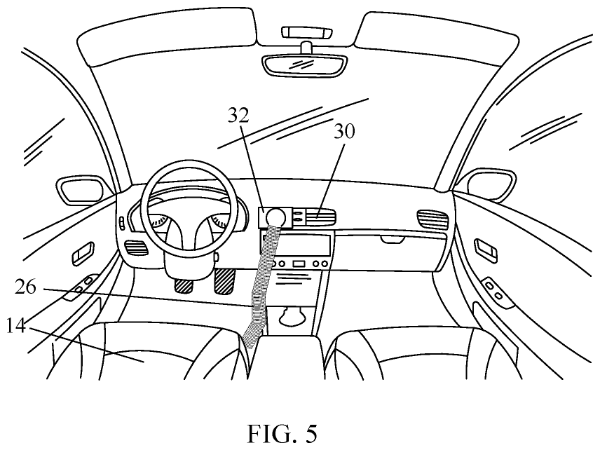

Referring to FIGS. 3 through 5, various exemplary implementations of the seat cushion 14 are illustrated. For example, in FIG. 3, a rear seat 11 of the vehicle can include the seat cushion 14. The hose 26 can extend from the connector 24 on the fan 22 to a connector 32 that is attached to an air vent 30 of the vehicle. In FIGS. 4 and 5, passenger and driver seats 13, respectively, as shown with the seat cushion 14 connected to the air vent 30 via hose 26.

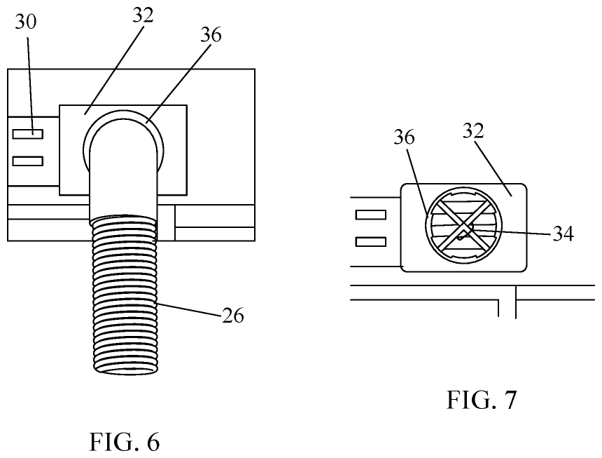

Referring to FIGS. 6 and 7, the hose 26 can connect to the vent 30 with a connector 32. The connector 32 can include a hose coupling 36 for removably attaching the hose 26. The hose coupling 36 may be formed in various manners, provided that the hose coupling 26 provides a removable connection between the connector 32 and the hose 26. Such a connection can include a twist-lock connector, a friction fit connector, a resilient pin lock connector, or the like. Thus, when the seat cushion 14 is not being used, such as during times of temperate temperatures, the hose 26 may be moved away. In some embodiments, the connector 32 may be attached to the air vent 30 with one or more attachment bands 34, such as wires, clips, or the like. The attachment bands 34 may attach to the air vent 30 and secure the connector 32 thereto. As can be seen in FIG. 7, when the hose 26 is removed, the air vent may be used in nearly the same manner as if the connector 32 was not in place, with minimal restriction in the air flow.

Referring back to FIGS. 2A and 2B, as can be seen, a top end 40 of the seat cushion 14 can include an opening 42 that permits air to flow out into the vehicle after passing between the two plastic pieces of the perforated plastic 18 (see FIG. 2C). Thus, air can continually flow along the seat cushion 14, in a direction generally parallel to the portion of the passenger's body positioned on the seat cushion 14. This air flow can draw heat from or add heat to a passenger seated on the seat cushion 14. Unlike conventional ventilated seats, the air flows through the cushion and the velocity is continuous, as the air flow can escape out the opening 42 at the top end 40 of the seat cushion 14, as indicated by arrows 44. Such a design also moves the “used” conditioned air (used in that there may have been some heat exchange between the passenger and the air flow, thus changing the temperature of the air exiting the seat cushion at the opening 42 as compared to the incoming air at the fan 20) back into the vehicle, thus maintaining an air flow in the vehicle.

While the seat cushion may be used as an add-on feature to any car seat, in some embodiments, the seat cushion design, as described herein, may be formed integrally with the car seat. In this embodiment, a dedicated hose may be provided in the vehicle to permit connection to a flow of conditioned air. Like the embodiments discussed above, in the integrated embodiment, the air can still continuously flow from the bottom of the seat cushion to the top and exit out of the top thereof.

It should be understood that the seat cushion 14 may be usable without a fan 20, where the force of the air out of the conditioned air vent may be used to move air through the seat cushion 14. In some embodiments, the seat cushion 14 may be usable with the fan 20, but without the hose 26 being connected to the air vent. In this embodiment, the flow of air may help keep the passenger more comfortable than without any air flow moving under the passenger.

The seat cushion 14 may be formed as a single piece, where the air flow from a seat portion 50 of the seat cushion 14 may move into the back portion 52 of the seat cushion and then exit out of the openings 40 at the top of the seat cushion 14. In other embodiments, the fan 22 may separately provide air flow to the seat portion 50 and the back portion 52, where the seat portion 50 can include its own exit openings at a distal end thereof, thus permitting air flow, generally parallel to the surface of the seat cushion 14 in both the seat portion 50 and the back portion 52.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A seat cushion for supporting a passenger, comprising:
an air inlet located at a first end of the seat cushion;
an air exit located at a second end of the seat cushion, the second end being opposite the first end; and
an air flow path operable to permit air flow from the air inlet to the air exit, the air flow path being located along at least one of a seat back portion and a seat portion of the seat cushion, the air flow path providing an air flow in a direction generally parallel to a plane defined by an outer surface of the seat cushion.

2. The seat cushion of claim 1, further comprising a two-piece perforated member defining the air flow path between the two pieces.

3. The seat cushion of claim 2, wherein the two-piece perforated member is formed from a plastic that maintains the air flow path when the passenger is seated on the seat cushion.

4. The seat cushion of claim 2, wherein perforations of the two-piece perforated member are disposed on an outer side thereof, the perforations covered with a breathable fabric operable to provide a seating surface for the passenger.

5. The seat cushion of claim 1, further comprising a breathable fabric forming an outer surface of the seat cushion, the breathable fabric permitting heat exchange between the passenger and air flowing through the air flow path.

6. The seat cushion of claim 1, further comprising a fan for delivering fan pushed air into the air inlet.

7. The seat cushion of claim 6, wherein the fan includes a fan power cord and fan controller for providing operating power to the fan.

8. The seat cushion of claim 6, further comprising a hose connection on the fan, the hose connection permitting a removable attachment of a first end of a hose thereto.

9. The seat cushion of claim 8, further comprising an air vent connector, the air vent connector operable to attach to an air vent of a vehicle, the air vent connector operable to attach to a second end of the hose, wherein conditioned air exiting the air vent is movable through the hose and fan, into the seat cushion.

10. The seat cushion of claim 1, further comprising a hose connectable between the air inlet of the seat cushion and an air vent of a vehicle, the hose operable to deliver conditioned air expelled from the air vent to move through the seat cushion and out an air outlet thereof.

11. A seat cushion for supporting a passenger, comprising:
an air inlet located at a first end of the seat cushion;
a fan for delivering fan pushed air into the air inlet;
an air exit located at a second end of the seat cushion, the second end being opposite the first end;
an air flow path operable to permit air flow from the fan to the air exit, the air flow path being located along at least one of a seat back portion and a seat portion of the seat cushion, the air flow path providing an air flow in a direction generally parallel to a plane defined by an outer surface of the seat cushion; and
a two-piece perforated member defining the air flow path between the two pieces.

12. The seat cushion of claim 11, wherein the two-piece perforated member is formed from a plastic that maintains the air flow path when the passenger is seated on the seat cushion.

13. The seat cushion of claim 11, wherein the fan includes a fan power cord and fan controller for providing operating power to the fan.

14. The seat cushion of claim 11, further comprising a hose connection on the fan, the hose connection permitting a removable attachment of a first end of a hose thereto.

15. The seat cushion of claim b4, further comprising an air vent connector, the air vent connector operable to attach to an air vent of a vehicle, the air vent connector operable to attach to a second end of the hose, wherein conditioned air exiting the air vent is movable through the hose and fan, into the seat cushion.

16. A seat cushion for supporting a passenger, comprising:
an air inlet located at a first end of the seat cushion;
a hose fluidly connecting the air inlet with an air vent of a vehicle;
an air exit located at a second end of the seat cushion, the second end being opposite the first end;
an air flow path operable to permit air flow from the fan to the air exit, the air flow path being located along at least one of a seat back portion and a seat portion of the seat cushion, the air flow path providing an air flow in a direction generally parallel to a plane defined by an outer surface of the seat cushion; and
a two-piece perforated member defining the air flow path between the two pieces.

17. The seat cushion of claim 16, wherein the two-piece perforated member is formed from a plastic that maintains the air flow path when the passenger is seated on the seat cushion.

18. The seat cushion of claim 16, further comprising a fan for delivering fan pushed air from the hose into the air inlet.

19. The seat cushion of claim 18, wherein the fan includes a fan power cord and fan controller for providing operating power to the fan.
